(19) United States
(12) Patent Application Publication
(10) Pub. No.: US 2007/0129961 A1
(43) Pub. Date: Jun. 7, 2007

(54) VIRTUAL BUSINESS RESTRUCTURING METHODS

(75) Inventors: JAY SKIBINSKI, Alpharetta, GA (US); Phil Festa, Cumming, GA (US); David Greiner, Jackson, NJ (US); Shaun Seery, Singapore (SG)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Aktiengesellschaft

(21) Appl. No.: 11/622,798

(22) Filed: Jan. 12, 2007

Related U.S. Application Data
(62) Division of application No. 10/118,579, filed on Apr. 8, 2002.
(60) Provisional application No. 60/282,570, filed on Apr. 6, 2001.
(60) Provisional application No. 60/282,571, filed on Apr. 6, 2001.
(60) Provisional application No. 60/282,572, filed on Apr. 6, 2001.
(60) Provisional application No. 60/283,930, filed on Apr. 16, 2001.
(60) Provisional application No. 60/283,941, filed on Apr. 16, 2001.
(60) Provisional application No. 60/283,961, filed on Apr. 16, 2001.
(60) Provisional application No. 60/345,729, filed on Dec. 31, 2001.
(60) Provisional application No. 60/345,899, filed on Dec. 31, 2001.
(60) Provisional application No. 60/345,901, filed on Dec. 31, 2001.

(51) Int. Cl. G06Q 99/00

(52) U.S. Cl. 705/1

(57) ABSTRACT

Virtual restructuring methods according to the present invention provide a mechanism for a diversified company or a joint business enterprise encompassing a plurality of business units having a degree of autonomy over their business operations, and having their own business methods and legacy information systems, to nevertheless reach customers as a virtual intergraded entity, through a common portal and a single user interface.

### CROSS-REFERENCE TO RELATED APPLICATIONS

The present patent document is a divisional of application Ser. No. 10/118,579 filed Apr. 8, 2001, which claims the benefit of the filing date under 35 U.S.C. §119(e) of Provisional U.S. Patent Application Ser. No. 60/282,570, filed Apr. 6, 2001; 60/282,571, filed Apr. 6, 2001; 60/282,572, filed Apr. 6, 2001; 60/283,930, filed Apr. 16, 2001; 60/283,941, filed Apr. 16, 2001; 60/283,961, filed Apr. 16, 2001; 60/345,729, filed Dec. 31, 2001; 60/345,899, filed Dec. 31, 2001; and 60/345,901, filed Dec. 31, 2001. All of the foregoing applications are hereby incorporated by reference.

### FIELD OF THE INVENTION

The present invention relates generally to the field of electronic business (“e-business”), and, more particularly, to the field of business-to-business (“B2B”) electronic commerce and transactions (“e-commerce”).

### BACKGROUND

In a fast-paced, global economy, where companies and other institutions have access to a multitude of options for purchasing many of the goods and services they require, and are also faced with a wealth of information regarding those options, the task of managing their marketplace options is a formidable one. In order to manage down the complexity of their purchasing function, potential customers increasingly demand one-stop shopping for goods and services that they consider related or synergistic, whether or not such relation or synergy is readily apparent to their vendors.

Despite the advantages offered by recent developments in tools for conducting e-business, the demand for true one-stop shopping is difficult for most companies to deliver on. Many companies are too specialized to deliver a breadth of goods and services to industrial customers, or too small to deliver desired goods or services in the volumes needed. Conversely, for large diversified companies, such as a conglomerate or even a more focused diversified company, lack of nimbleness may be a problem. While they may have sufficient depth and breadth of product line to satisfy industrial customers, their large size and de-centralized management structures may make the time needed to fulfill customer requirements unacceptably long. For example, a diversified company having such diverse businesses as medical, telecom, industrial power, lighting, automotive, logistics, building technologies, credit and finance, plastics, aircraft engines, or the like, their disparate methods of doing business can hamper the ability of these business units to work together as an effective, unified, e-business presence.

The same can be true for any diversified company, or joint business enterprise (such as a strategic alliance, joint venture, consortium or other enterprise), in which the individual business entities or units have a greater or lesser degree of autonomy. The diversified company or joint business enterprise may be unable to effectively present a unified face to its customers that fully capitalizes on or develops its brand equity or its latent abilities to cross-sell between those business units and fully satisfy customer demands. One reason is that the component entities of a diversified company or joint business enterprise (e.g., divisions, subsidiaries, affiliates, joint venture entities, recently acquired or merged entities) that would benefit from a rapidly deployable common e-business portal may have widely differing information infrastructures. The result of their failure to work together in the electronic marketplace can include lost marketing opportunities and sales, customer dissatisfaction with the difficulty of working with disparate business units under a single corporate banner, delay and other inefficiencies.

As described above, providing one-stop shopping to large institutional customers, even for large, diversified companies that theoretically have the resources to do so, is in reality a steep logistical challenge. Large, de-centralized, diversified companies with a number of business units find it difficult to anticipate varied and variable customer needs. Even when they are able to discern such needs, the companies have difficulty amassing the resources necessary to fill them in a short period of time. Part of the problem is the difficulty of efficiently and effectively collecting and disseminating the necessary information across business units, each of which may have its own information infrastructure and ways of doing business. Another challenge is coordinating the company's processing of diverse requests from the same customer to ensure delivery of the desired products or services from the appropriate business units. Additionally, the company and its business units must manage the difficult task of delivering the many and diverse products and services across their own heterogeneous back-office systems, without confusing the customer as to where the products and services are coming from. The company and its business units must present a unified point of contact, allowing for customer assurance regarding quality of the product or service.

A solution to this problem would allow diversified companies to provide custom-tailored goods and services offerings to each of a shifting group of industrial customers with ever changing needs. It might also enable diversified companies to present a different bundle of products and services every time a customer requests it, each time configuring the bundle according to the specific request of the moment. From a customer perspective, the diversified company must behave as if it were a wholly different, unified company for the purposes of each distinct request. From the company's perspective, it needs to operate with a common customer face and on a common platform in order to facilitate coordination among diverse business units, without necessitating extensive modifications to existing information and business systems within such business units, and without necessitating extensive re-training and change management requirements among employees of the business units. To date, a solution that would allow a large diversified company to virtually restructure itself, as alluded to above, has not presented itself. As a result, corporate efficiency in identifying and serving potential customers is hampered, customer satisfaction levels are not what they could be, and the overall number of synergistic transactions that large diversified companies are able to complete is limited.

### SUMMARY OF THE INVENTION

The present invention relates to an methods for virtually restructuring a diversified company comprising disparate business units, or a joint business enterprise comprising various entities, such that it may serve a large, dispersed, mutable customer base in a competitive market for goods and services (also referred to, collectively, herein as “offerings”). The invention provides methods by which the diversified company or joint business enterprise can seamlessly provide for customer access to goods and services from any and all of its business units or entities though a common portal as if the customer were acting with a single business unit or entity. It provides a method for a diversified business or joint business enterprise to take advantage of the breadth and strength of a large group of business units, while demonstrating the nimbleness and flexibility of a much smaller company. Similarly, it allows the diversified business or joint business enterprise to capitalize more quickly and fully on the company's brand equity and on its previously unexploited opportunities to cross-sell to customers of a particular business unit relevant offerings from other business units with which the customer may not previously have done business. The company is able to virtually restructure itself, drawing on and combining the offerings of its often fragmented business units, and transforming them into a single, unified corporation for purposes of serving an individual customer.

In an aspect of the present invention, a method provides a customer with content relating to offerings of a plurality of business units of a diversified company or of a joint business enterprise. The method comprises the steps of receiving a request for content relating to a first business unit, as a function of the identity of the first business unit and of the identity of the customer, selecting a second of the plurality of business units, retrieving content relating to the second business unit, and transmitting to the customer information comprising first requested content along with the content relating to the second business unit.

Another aspect of the present invention involves a method for providing e-business services between a customer and a plurality of business units of a diversified company or joint business enterprise, where each business unit is associated with a corresponding information system. The method comprises several steps: A common on-line portal for the plurality of business units is provided, the common portal comprising a single user interface for the plurality of business units. A first request is received from the customer via the single user interface, the first request directed to a first of the plurality of business units of the diversified company. As a function of the first request, a first response is retrieved, based on data derived from the information system associated with the first business unit. The response is transmitted to the customer via the single user interface. A second request may then be received from the customer via the single user interface, the second request directed to a second of the plurality of business units. As a function of the second request, a second response based on data derived from the information system associated with the second business unit is retrieved, the information system associated with the second unit differing from the information system associated with the first business unit. The second response is transmitted to the customer via the single user interface. By way of this method, the customer may direct requests to at least two business units electronically via the common on-line portal.

Another aspect of the present invention concerns a method for initiating and completing an e-business transaction over a network between a customer and a plurality of business units of a diversified company, each business unit associated with a corresponding information system, the customer being identified by a set of customer-specific information. A common on-line portal for the plurality of business units is provided. The common on-line portal comprises a single user interface for conducting e-business with the plurality of business units. A communication directed to a first of the plurality of business units, having a first associated information system, is received from the customer via the single user interface. As a function of the identity of the first business unit, and of at least a subset of the set of customer-specific information, a second of the plurality of business units is selected. The information system associated with the second of the plurality of business units (which differs from that of the first) is queried. Data associated with the second business unit is then retrieved. A message is transmitted to the customer, the message based on the data retrieved from the information system associated with the second business unit. By way of the method, a customer may direct requests to at least two business units electronically via the common on-line portal.

Another aspect of the present invention relates to a method, implemented in an electronic business information system, for initiating and completing an e-business transaction over a network between a customer identified by a set of customer-specific information and a plurality of business units of a diversified company (or joint business entity). Each business unit is associated with a corresponding information system in communication with the electronic business information system. A common on-line portal for the plurality of business units is provided, the common on-line portal comprising a single user interface for conducting e-business with the plurality of business units. A transaction request directed to a first of the plurality of business units of the diversified company, having a first associated information system, is received from the customer via the single user interface. As a function of the identity of the first business unit, and of at least a subset of the set of customer-specific information, a second of the plurality of business units is selected, as is a transaction. The information system associated with the second of the plurality of business units is queried for information related to the selected transaction, the information system associated with the second business unit differing from the information system associated with the first business unit. Data from the information system associated with the second business unit is retrieved in response to the query, and a message is transmitted to the customer, the message based on the data retrieved from the information system associated with the second business unit. A confirming message is received from the customer via the single user interface, as is a message from the customer comprising a commitment to pay value in connection with the transaction.

These and other aspects of the invention, along with various features and advantages, are disclosed in the appended documentation and are covered, in whole or in part, by the appended claims.

### BRIEF DESCRIPTION OF THE DRAWINGS

FIG. 1 shows a portal in an embodiment of the present invention providing common customer access to the various business units of a diversified company.

FIG. 2 shows an embodiment of a web page associated with a single user interface associated with the common diversified company portal of FIG. 1.

FIG. 3 shows an embodiment of a second web page associated with the single user interface of the common portal of FIG. 1, including a personalization content management frame associated with a particular customer and relating to a particular business field of interest to the customer, in this example, the automotive industry.

FIG. 4 shows an embodiment of a third web page associated with the single user interface of the common portal of FIG. 1, providing more detailed information regarding a particular customer order.

FIG. 5 shows an embodiment of a fourth web page associated with the single user interface of the common portal of FIG. 1, to which the customer hyperlinks from the web page of FIG. 4.

FIG. 6 shows the web page of FIG. 5, including dialog box linked by an interrogatory icon that pops up in a central block of the screen for customer entry of a question.

FIG. 7 shows an embodiment of a portable, hand-held computing device, displaying a question entered by the customer using the dialog box of FIG. 6.

FIG. 8 shows an embodiment of advertisement on a web page to which the customer may link from the common diversified company portal of FIG. 1, the advertisement relating to a different business field (medical) than that associated with FIGS. 3-7 (automotive).

FIG. 9 shows an embodiment of tailored content (here, medical news) relevant for a second customer interacting with the common diversified company portal, the tailored content derived from the source shown in FIG. 8.

FIG. 10 shows an embodiment of tailored content in the form of a project management timeline offering to a customer, information for which may be extracted from one or more of the plurality of business units of the diversified company, according to the present invention.

FIG. 11 shows an embodiment of an aspect of the present invention according to which further tailored content is provided, in the form of an accounting frame organizing customer invoices corresponding to the projects and displaying costs associated with tasks and sub-tasks.

FIG. 12a shows an embodiment of an aspect of the present invention according to which a customer is presented with a frame in which to make payment on-line for any of the costs associated with the several projects tracked by the project management timeline shown in FIG. 10.

FIG. 12b shows an embodiment of an aspect of the present invention in which a customer is presented with an advertising or promotional message of a selected one of the plurality of business units of the diversified company.

FIG. 13 shows an embodiment of a system according to the present invention for processing e-business transactions between a customer and a plurality of business units of a diversified company.

FIG. 14 shows an embodiment of a presentation layer associated with the system for processing e-business transactions according to the present invention.

FIG. 15 shows an embodiment of an applications layer associated with the system for processing e-business transactions according to the present invention.

FIG. 16 shows an embodiment of a legacy applications layer associated with the system for processing e-business transactions according to the present invention.

FIG. 17 shows an embodiment of an architecture of a system according to the present invention, depicting customer access, security and web-hosting features.

FIG. 18 shows an embodiment of a method according to the present invention for providing a customer with content relating to the offerings of a plurality of business units of a diversified company.

FIG. 19 shows a further embodiment of a method according to the present invention for providing a customer with content relating to the offerings of a plurality of business units of a diversified company.

FIG. 20 shows an embodiment of a method according to the present invention for providing e-business services between a customer and a plurality of business units of a diversified company, each business unit associated with a corresponding information system.

FIG. 21 shows an embodiment of a method according to the present invention for initiating and completing an e-business transaction over a network between a customer and a plurality of business units of a diversified company, each business unit associated with a corresponding information system, the customer being identified by a set of customer-specific information.

FIG. 22 illustrates an embodiment of a method according to the present invention, in an e-business information system, for initiating and completing an e-business transaction over a network between a customer and a plurality of business units of a diversified company, each business unit associated with a corresponding information system in communication with the electronic business information system, the customer being identified by a set of customer-specific information.

FIG. 23 shows an embodiment of a method according to the present invention for providing a customer with content relating to the offerings of a plurality of business entities associated with a joint business enterprise.

FIG. 24 illustrates an embodiment of a method according to the present invention for providing e-business services between a customer and a plurality of business entities of a joint business enterprise, each business entity associated with a corresponding information system.

FIG. 25 shows an embodiment of a method according to the present invention for initiating and completing an e-business transaction over a network between a customer and a plurality of business entities of a joint business enterprise, the customer being identified by a set of customer-specific information.

FIG. 26 illustrates a method according to the present invention for initiating and completing, in an electronic business information system, an e-business transaction over a network between a customer and a plurality of business entities of a joint business enterprise, the customer being identified by a set of customer-specific information.

### DESCRIPTION OF THE INVENTION

In a diversified company or a joint business enterprise, a plurality of business units may operate with any degree of independence, yet provide goods and services that may benefit a common customer base. These business units may, either individually or collectively, possess any of a wide variety of corporate structures. In one scenario, the business units may be owned in whole or in part by a common entity, yet effectively operate as separate business concerns. In such a diversified company, products and/or services provided by the various business units may or may not have common customer bases or related markets. In another scenario, the business units may be joint venture or strategic partnership entities, jointly owned and managed by two or more companies. In still another scenario, the business units may be two or more companies that have recently merged, and that seek to present a common face to customers even before combining their information systems and back-office processes. In the description provided below, where reference will frequently be made to diversified companies, the description generally may apply as well to joint business enterprises, even if not specifically stated.

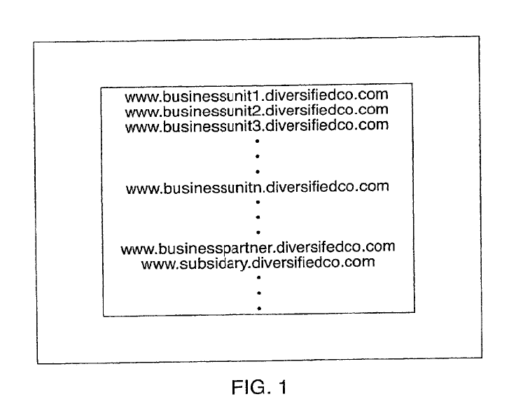

As shown in FIG. 1, the present invention virtually organizes the several business units, and, indeed, business partners, subsidiaries and other entities of the diversified company into a single, cohesive, virtual entity that, one might say, speaks to the customer with a single voice: the customers of different units of a diversified company are offered products and services from a single common portal.

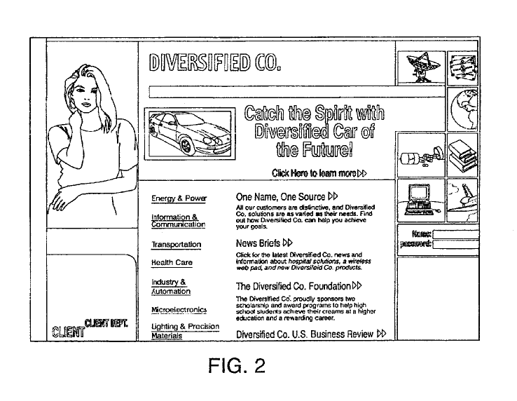

As shown in FIG. 2, a common portal is provided whereby several products and services from various entities of a diversified company are made available for sale to an on-line customer. The common portal, in one preferred aspect of the present invention, includes a pre-selected format in which various sections of the portal are arranged into discrete portions having assigned functions. Providing an ordered arrangement of the common portal in this manner facilitates customer relations by furnishing the customer a consistent and familiar format with which the customer can become comfortable and learn to navigate with facility. In another aspect, the common format remains constant, regardless of the information that is displayed. The customer's increased comfort with the portal helps to foster a loyal relationship between the customer and the diversified company.

In FIG. 2, the predetermined format comprises a pre-selected set of locations, or blocks (in HTML, tables) on the portal display where particular types of content (e.g., product information, order status, or interactive areas) are provided. For example, a customer identification area is provided in the upper-left portion of the portal. In the illustrated embodiment, the customer ID area displays a personalized photo of the particular customer. The central upper portion is reserved for conveying company information such as the name of the company and/or the company logo. The lower left-hand portion is allocated to conveying the type of content offered within the particular view of the common portal. The block below the central-upper block may be allocated for an advertisement or information that provokes the customer to interact with the other elements of the portal. The right hand block is designed in this example to be less uniform in shape in order to impart an aesthetic sense to the portal. In any event, the right hand portion is reserved for individual blocks, which may be hyperlinked, that convey icons representing the various businesses or products offered by those businesses of the diversified company. The block below the aesthetic block provides a dialogue box for accepting a login username and password. The central-lower block is reserved for specific page information relating to the type indicated in the block above.

In FIG. 2, the lower-central block, in one view, or frame, is reserved for hyperlinks to products and services oriented by market, such as hyperlinks for Energy & Power, Information & Communication, Transportation, Health Care, Industry & Automation, Microelectronics, Lighting & Precision Material, etc. There may also be hyperlinked information regarding the offered products and services, including product and services news, company news, good-will programs, market news, etc. The invention is not limited to the specific information and hyperlinks described above and may include other similar arrangements.

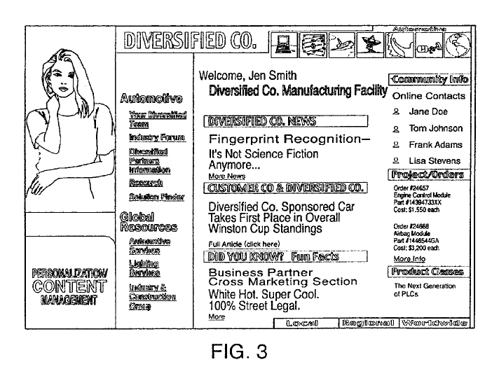

FIG. 3 depicts another frame within the common portal format. The common portal blocks in both frames (FIGS. 2 and 3) share a common format. The blocks are arranged in substantially identical or similar locations on the portal. Some blocks within an overall, general, pre-selected format may be modified to accommodate various types of information. A common pre-selected format facilitates customer recognition and fosters familiarity of the customer with the portal and between frames of the common portal. In the illustrated frame, more detailed information is provided, as are hyperlinks relating to the automotive industry.

A personalization content management frame is provided, as indicated in the identification block in the lower left-hand of the frame. This frame displays personalized content of a particular customer. Also, community information is provided in a block in the middle of the right-hand side, geared toward a customer who is in the automotive industry. A block in the middle of the lower right-hand side provides the customer's order information, which may be hyperlinked to a frame including more detailed information about the selected order. In the lower right-hand side, a block describes next generation products, which may be determined based on the product purchase or order history of the particular customer.

The manner in which product and/or service offerings are made to the customer may be determined, in part, by categorizing them into clusters that have common buyers. Clustering can be done by examining customer history, product synergy, or other factors. Customers who purchase, for example, MRI machines, may be likely to purchase complementary or synergistic offerings such as analytical software for analyzing MRI images. Offerings may further be clustered according to the customer type. A hospital is more likely to purchase MRI machines than a power plant turbine. Clustering is discussed at greater length below.

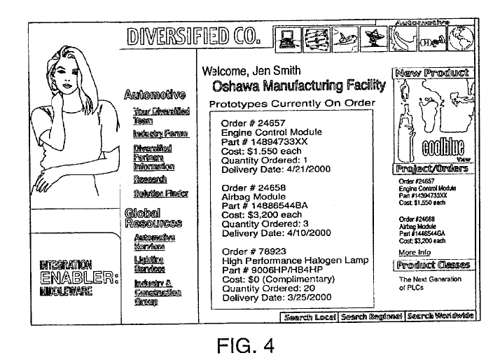

In FIG. 4, a frame is shown that provides more detailed information regarding a particular order. Included with the information of the selected order are, in one example, related orders that pertain to the same project as shown in the middle block. As shown in the figure, the project ID is provided in the identification block. When a specific order is selected by the customer and displayed in such a frame, advertising blocks directed to new products, and hyperlinks to additional information regarding the advertised product predetermined to be of interest to that customer based on the type of project, may be displayed according to the present invention.

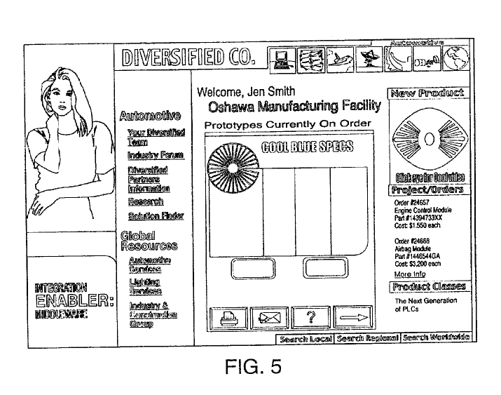

FIG. 5 illustrates hyperlinking by a customer to an advertised product, providing in the same portal a more detailed description of the advertised product. In the central block of the illustrated web page, an interactive advertisement has clickable icons enabling a customer to interactively view the product specifications. A print button in the central block encourages the customer to print, and hopefully disseminate or more fully absorb, the information. An email icon allows the customer to contact the diversified company electronically, such as an individual or entity responsible for that product. The addresses of such individuals or entities may be pre-selected and set as parameters of the portal. An interrogatory icon may be provided to hyperlink to a FAQ (Frequently Asked Questions) block, help wizard, or other information. Another icon may be provided to allow the customer to proceed or return to other blocks of information at the speed which the customer selects.

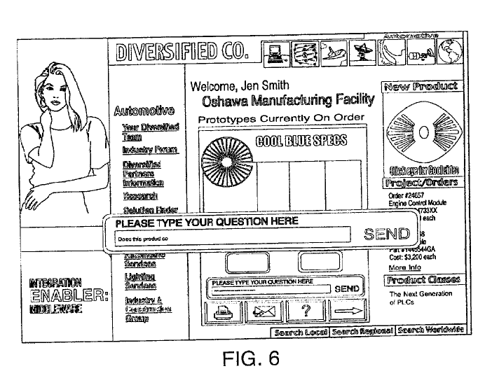

In FIG. 6, an aspect of the present invention includes an interrogatory icon linked to a dialog box that “pops up” in the central block that provides a larger input area for the customer to enter his/her question. The figure shows a blown-up view of the interrogatory dialog box for purposes of illustration; the actual frame appears below the enlarged view.

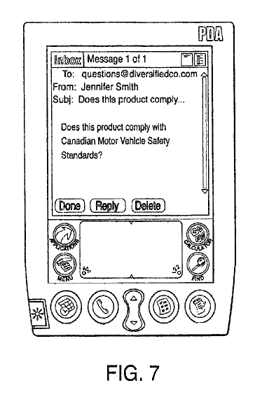

In one of its aspects, the system and method according to the present invention receive the customer's question via the dialog box and transmit it to a portable hand-held device, such as a personal digital assistant (PDA), mobile phone, or similar equipment. FIG. 7 shows the text of the question that has been downloaded to the PDA. According to an aspect of the present invention, the diversified company correspondent to whom the question has been sent replies directly on the remote device and the answer is transmitted back to the system and downloaded to the customer. In this manner, the system and method according to this aspect of the present invention are capable of providing virtually immediate and personalized customer service, thereby improving customer-relations.

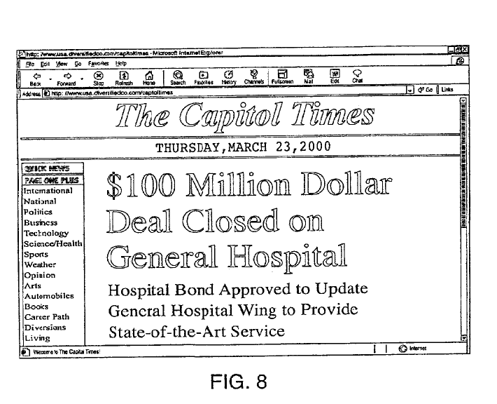

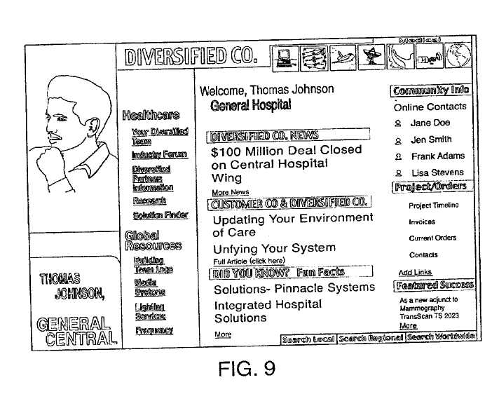

FIG. 8 is an illustration of content on a typical HTML web page, a news article relating to the medical industry, a different business field than the automotive industry treated in FIGS. 3-7. Here, a different customer is illustrated in the personalized photo block of the portal (although the first customer could just as easily access the same content, if desired). The customer may not otherwise necessarily have ready access to, or be timely informed of, the news reported in the article. To ensure prompt receipt of time-sensitive industry-specific content, such as the news content shown in FIG. 8, the present invention, as illustrated in FIG. 9, displays content ported from the news article of FIG. 8, along with other news stories that selected for their relevance to the expressed interests of the customer. The content may, as shown, be provided in summary form in the central block of a frame dedicated to providing news to the customer. The customer-tailored content, including information from trade articles, provides a basis for repeated customer visits to the portal and may encourage purchases.

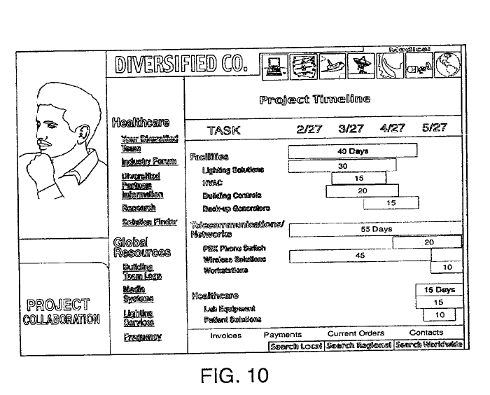

A variety of services may be provided to the customer via the common portal of the diversified company. As shown in FIG. 10, for example, the portal may offer tracking of a project or order for the customer, including a timeline. According to the present invention, the underlying information used to generate the timeline may be extracted from one or more of the plurality of business units of the diversified company, via the systems and methods described below.

In the embodiment shown in FIG. 10, information has been extracted from the facilities business unit, telecommunications business unit, and healthcare business unit. The timeline, situated in the central block of the project frame, is arranged with a time scale along the upper section of the central block, though it could be displayed elsewhere on the page. Each project task is arranged in a record format; sub-tasks associated with each project task are displayed under each task heading. Adjacent each of the sub-tasks is a time stamp that indicates the length of time that the task and sub task should require.

An embodiment of a method according to the present invention updates the timelines and task (or sub task) information dynamically for the customer, providing a tool for the customer to track and manage his or her projects. In the illustrated example, involving the construction of a hospital, the project tracking and management service is offered in conjunction with means to access the various business units of the diversified company that may offer products and services that may be necessary for the project, such as lighting, medical, telecommunications, building management or other businesses. As the customer's needs arise, the ability to meet many or all those needs are near at hand, accessible through the portal by hyperlinking. The diversified company, in an embodiment of the method and system according to the present invention, speaks to the customer with a single voice, providing complete construction management requirements and, in this example, doing so in a way that complements the customer's management approach.

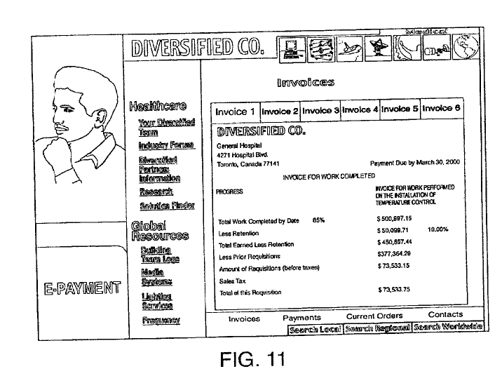

In another service provided by a system and method according to the present invention, shown in FIG. 11, an accounting frame organizes customer invoices corresponding to the projects and displays the costs associated with tasks and sub-tasks. Each invoice is dialog-tabbed, so that the customer may conveniently “flip” through the invoices by “clicking” on the appropriate tab, assisting the customer in managing the costs of his/her project(s).

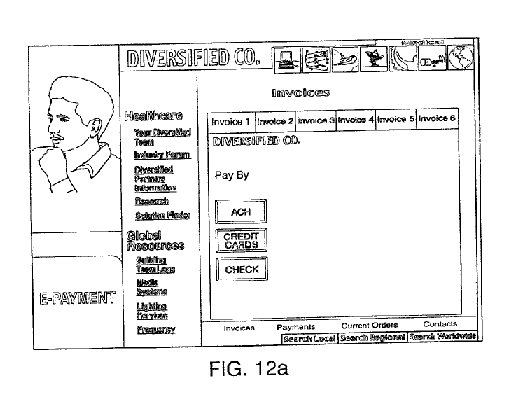

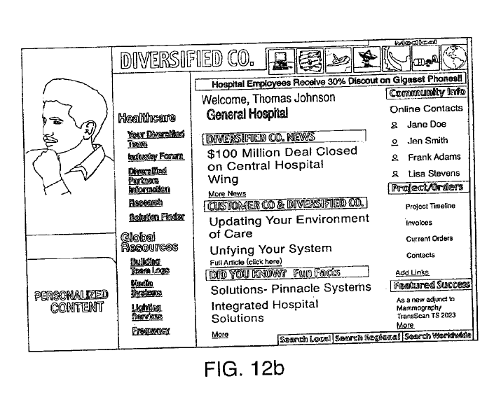

Referring to FIG. 12a, according to an aspect of the present invention, the customer is presented with a frame in which to make payment on-line for any of the costs associated with the several projects tracked by the system, including, without limitation, ACH, Credit or Check. The variety of payment methods offered assists the customer and increases the likelihood that the diversified company will receive payment in a timely manner.

According to another aspect of the system and method according to the present invention, as shown in FIG. 12b, the customer is presented with an advertising or promotional message that is selected as a function of the at least one of: the identity of the customer, the customer's transaction history, the business unit of the diversified company that the customer is dealing with. The customer may thus be presented with an advertising or promotional message of a selected one of the plurality of business units of the diversified company. For one example, and without limitation, a message is selected that helps to sell to the customer an offering of a business unit of the diversified company that the customer might have a need for, but for which the customer has no previous buying history. In the illustrated example, where the customer has been managing the construction of a hospital, the system according to the present invention identifies an existing promotion relating to telephones, sold by a telecommunications business unit of the diversified company with which the customer might not have previously engaged in any business. The message is displayed in the example at the top of the largest block at the right of the webpage: “Hospital Employees Receive 30% Discount on Gigaset Phones!”. The customer, informed about the special offer, is now in a position to consider either making a purchase on behalf of hospital employees or notifying hospital employees of the offer.

Another aspect of the present invention provides an on-line catalog apparatus, system and method wherein product and service offerings are categorized according to customer market clusters. The manner in which products and/or services are to be offered to the customer may be determined, in part, by categorizing them into clusters that have common buyers. Alternatively, offerings may be clustered according to their market synergy. Customers who purchase magnetic resonance imaging (MRI) machines, for example, may be likely to purchase complementary or synergistic products or services, such as software for analyzing MRI images. Products and services may further be clustered according to the type of customer. As discussed above, a hospital is a likely purchaser of an MRI machine, information and communications services, medical systems management software, for example, but is not generally expected purchase a power plant turbine. A customer-oriented market technique that looks at the market from the point of view of particular customer's purchasing needs can offer advantages to the diversified company or joint business enterprise, provided there is a system that permits the customer whose purchasing needs are understood to be in effective, coordinated communication with all of the business units. According to the present invention, market clusters are dynamically updated as market factors change.

Generating market clusters from a customer relations perspective involves the development of a customer profile and constructing the market cluster based on that profile and on various known industry factors. The profile may provide the basis for organizing the customer according to type, the customer's type depending upon the perspective of the diversified company. A customer may, for example, be of a medical, industrial equipment, semiconductor or other type. Products and services may then be offered, according to a pre-arranged scheme, to the market cluster or clusters comprising customer types that are likely to purchase such offerings. Medical imaging equipment, for example, may be clustered with hospital-related technologies or medical information systems, or even more disparate offerings such as building systems, energy systems, power quality systems, lighting products, credit and finance services, or any other businesses within the diversified company or joint business enterprise from which a medical imaging customer may need to procure products or services. Industrial customers, for another example, may have clusters that include programmable logic controllers and circuit breakers.

The market cluster may be further developed based on an analysis of customer purchasing history and predictions of future needs. The cluster definition may build upon an analysis of the purchasing needs of customers in market sectors covered by a cluster. This analysis may take into account business trends, mergers and acquisitions or other market events, and may be analyzed either continuously or periodically to provide a dynamic market cluster determination for the customer.

In an embodiment of this aspect of the present invention, a market cluster is assigned products and/or services according to the business unit. In another embodiment, the market cluster is determined based on products and/or services themselves, rather than on the business unit(s) that may market them. In a third embodiment, a cluster is determined on the basis of both the business units and on their product and service offerings.

The offerings associated with a given market cluster may be presented to a customer in various ways, including advertisements displayed on the common portal for the diversified company or joint business enterprise. They may also include special offerings displayed on the common portal. The advertisements can be of any type, including so-called banner advertisements or in the form of a table of suggested products or services displayed to the customer for a given project.

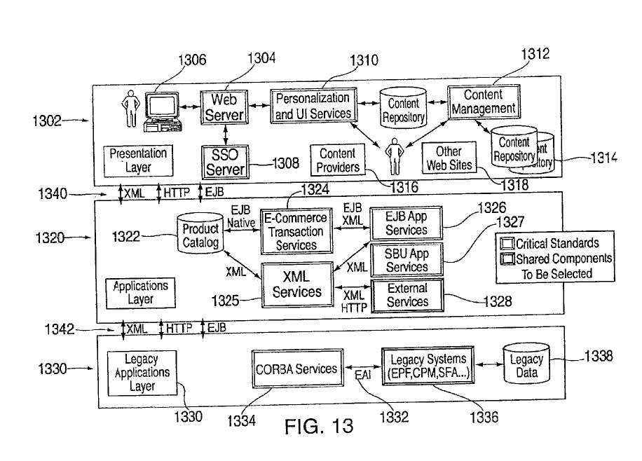

This aspect of the present invention may be delivered via any suitable communication network, such as an Ethernet or Internet or via telephone or cellular telephone protocols, e.g., Blue Tooth. In one embodiment, to which the invention is not limited, the advantages of the invention are provided via a system described below in connection with FIGS. 13-17. invention is practiced via any suitable communications network or on-line network, such as the Ethernet or Internet.

A standard format for displaying information, such as a portal, is provided that allows a user or customer to access the network of business units of the diversified company. The common portal preferably provides a single, or common, graphical user interface window or platform. Also in a preferred embodiment, the single user interface includes pre-selected areas, such as tables and dialog boxes dedicated to specific functions in a manner that is substantially fixed. For example, the table designated for displaying a picture of the offering is fixed in terms of its dimensions and its location on the display. Similarly, a dialog box for providing interactive sessions with the customer is fixed in its dimensions and its location on the display. Other designated areas, such as product description, company information and user profile are also fixed, with static dimensions and areas of the display. With a common portal, a user or customer is granted access seamlessly and transparently to any of the business units of the diversified corporation, in contrast to prior methods of merely linking internet sites and transferring the customer to an entirely different domain. The common portal, by contrast, can take advantage of available data sharing techniques, such as framing or data warehousing and mining, and can port data from the different business unit internet sites to a portion of the common portal. Information is presented to the customer from all the business units through a standard format, a single user interface.

An embodiment of a system according to the present invention that provides the advantages described above is shown in FIGS. 13-17. In one of its aspects, the system according to the invention provides three processing layers for handling communications and transactions between the customer and the diversified company. The upper one-third of FIG. 13 shows a “presentation layer” 1302. A web server 1304 communicates with a customer's computer 1306, and transmits content to it, over a network (e.g., the Internet). The web server 1304, in turn, communicates with a Server-Side Object (“SSO”) Server 1308, which includes sequences of code frequently used by the web server in processing customer queries, as well as with a personalization engine 1310. The personalization engine 1310 tailors content and transaction detail for a given customer based on a customer's profile, transaction history, and usage patterns. A content management application 1312 stores, maintains and transmits to the customer interface presently relevant content from disparate content repositories 1314 of the diversified company's operating units. Content may originate from external content providers 1316 or via links to external web sites 1318. According to the present invention, the presentation layer 1302 functions as the main content interface between the diversified company and the customer, consolidating and formatting transaction data and other content from across the diversified company's network for presentation to the customer.

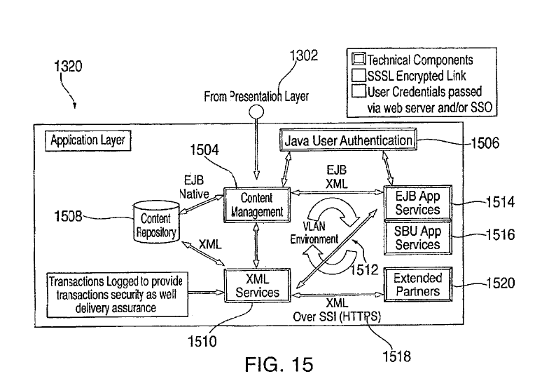

The middle one-third of FIG. 13 shows an “applications layer” 1320 in the illustrated embodiment of the invention, including a centralized, combined product database (or “Product Catalog”) 1322, an e-commerce server 1324, as well as Extensible Mark-up Language (“XML”) Services 1325, Enterprise Java Bean (“EJB”) Application Services 1326, SBU Application Services 1327, and External Services 1328 components, all of which facilitate sharing of data and business process rules among the databases and applications of the business units and of the diversified company. The e-commerce server 1324 in this example allows for transmission of order and payment information back to the presentation layer 1302 for formatting, and for transmission of updates to the legacy systems of the business units, which reside in a “legacy applications” layer 1330. The applications layer 1320 is described in greater detail below in the text associated with FIG. 15.

The lower one-third of FIG. 13 shows a “legacy applications layer” 1330. In the illustrated embodiment of this aspect of the present invention, the legacy applications layer 1330 includes an enterprise application integration engine (“EAI”) 1332 linking an open, preferably vendor-independent architecture and infrastructure services component that computer applications use to work together over networks, such as Common Object Request Broker Architecture (“CORBA”) 1334 (e.g., QMS), to the legacy application systems 1336 and databases 1338 of the business units. Using the standard protocol IIOP (Internet Inter-ORB protocol), a CORBA-based or similar program from any vendor, on almost any computer, operating system, programming language, and network, can interoperate with a CORBA-based program from the same or another vendor, on almost any other computer, operating system, programming language, and network.

This CORBA component 1334 allows the programming objects native to each business unit's legacy system 1336 to communicate with each other, regardless of programming language or operating system. The EAI's 1332 functionality includes: database linking, in which databases share and duplicate information; application linking, in which the diversified company or its units share data or processes between two or more applications; and data warehousing, in which data is extracted from multiple sources and written to a single database for analysis.

The embodiment of the aspects of the invention illustrated in FIG. 13 also includes data exchange and communication among the presentation layer 1302, the applications layer 1320, and the legacy applications layer 1330. Product and customer information relating to a customer request, or requests, is transmitted between the presentation layer 1302 and the applications layer 1320 using XML, Hypertext Transfer Protocol (“HTTP”), and EJB 1340. Transmission of post-transaction updates to the data repositories of the legacy applications layer 1330 from the e-commerce server 1324 and product catalog 1322 of the applications layer 1320 are also accomplished using XML, HTTP, and EJB 1342.

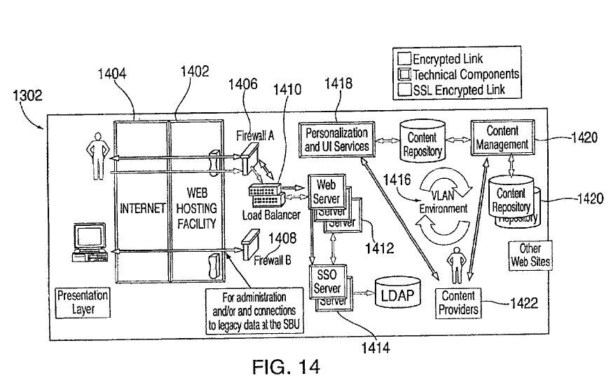

FIG. 14 illustrates in further detail a particular aspect of the presentation layer 1302 of the invention. The left corner of FIG. 14 shows a web hosting facility 1402 managing information transfer between the Internet 1404 and the diversified company's (or joint business enterprise's) computer network. This example of the invention includes two firewalls: Firewall A 1406 intercepts and examines messages transmitted from the customer in order to prevent unauthorized access to the diversified company's network; Firewall B 1408 intercepts and examines messages transmitted from the legacy systems of the business units. Messages that have passed through Firewall A 1406 are fed into a load balancer 1410 (shown in the center of FIG. 14), and then distributed to one of several Web servers 1412 according to the then-current capacity utilization of each server. The chosen Web server accesses code for its processing tasks by linking to a corresponding SSO server 1414, shown in the lower half of the center of FIG. 14. The right corner of FIG. 14 shows a virtual LAN (“VLAN”) environment 1416 connecting the personalization engine 1418, content management application 1420, and external content providers 1422 described above.

FIG. 15 shows in further detail an embodiment of the applications layer 1320 according to the present invention. User queries and transaction requests are transmitted from the presentation layer 1302 to the content management application 1504 shown in the center of FIG. 15. After verification of user identity and access privileges by a Java user authentication engine 1506 (shown in the upper right corner of FIG. 15), content relevant to the customer request is extracted from the content repository 1508 using EJB, and transactions are logged in the XML services component 1510 to provide a security and delivery assurance record. A VLAN environment 1512, shown in the right half of FIG. 15, connects the content management application to the EJB application services 1514, SBU application services 1516, and XML services components 1510. XML instructions and a Server-Side Include (“SSI”) 1518 are utilized in order to dynamically generate content pages from external partners 1520 (shown in the lower right corner of FIG. 15) for transmission to customers in response to their content requests.

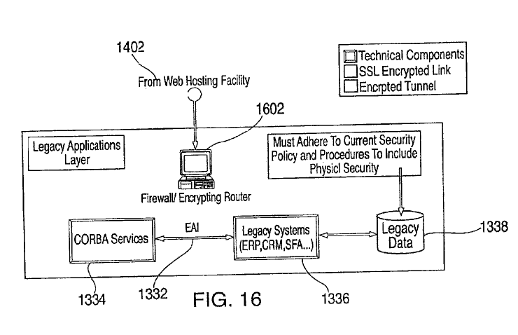

FIG. 16 illustrates in further detail an embodiment of the legacy applications layer 1330 according to an aspect of the present invention. The illustrated embodiment includes a firewall/encryption router 1602 residing between the legacy applications layer and the Web hosting facility 1402. This router examines transmissions between the legacy systems of the business units and the invention and determines whether they meet specific security criteria. Further shown in FIG. 16 are the EAI 1332, described above, linking the CORBA services component 1334 (e.g., OAM) to the legacy application systems 1336 and databases 1338 of the business units.

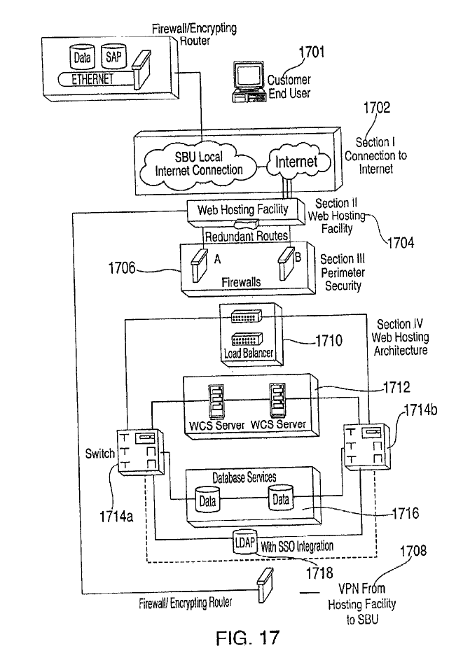

Referring to FIG. 17, the customer 1701 connects to the diversified company's system in Section 11702 and transmits queries and transaction requests through the Web hosting facility 1704 shown in Section II. The Web hosting facility connects to redundant firewalls 1706, providing perimeter security functionality for the system (shown in Section III of FIG. 17), and also connects to the legacy systems of the business units via a virtual private network (“VPN”) 1708. Section IV of FIG. 17 shows an overview of a Web hosting architecture in an embodiment of an aspect of the present invention. A load balancer 1710 receives a communication from one of the firewalls and routes it to the appropriate Web server 1712, based upon capacity. The invention thus allows for the handling of a multiplicity of user requests from the customers of any of its numerous business units without overburdening any one Web server. The request can then be processed via one of several switches 1714a, 1714b to the data repositories 1716 or LDAP facility 1718 shown in Section IV of FIG. 17.

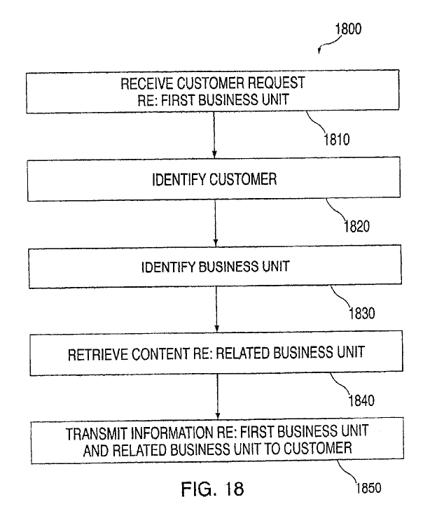

FIG. 18 illustrates an embodiment of a method according to the present invention for providing a customer with content relating to the offerings of a plurality of business units of a diversified company. A customer request is first received regarding a first business unit at 1810. At 1820, the customer is identified, and at 1830, the business unit is identified. Content is retrieved 1840 regarding a related business unit. At 1850, information regarding the first business unit and the related business unit is transmitted to the customer.

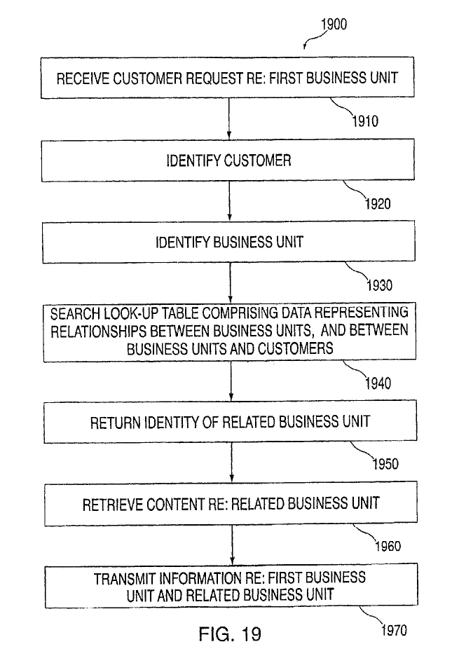

FIG. 19 shows a further embodiment of a method according to the present invention for providing a customer with content relating to the offerings of a plurality of business units of a diversified company. At 1910, a customer request regarding a first business unit is received. The customer is identified, 1920, and the business unit is identified, 1930. At 1940, a search of a look-up table is conducted, the look-up table comprising data representing relationships between business units, and between business units and customers. At 1950, the identity of a related business unit is returned. Content is then retrieved regarding a related business unit 1960, and information regarding the first business unit and the related business unit is transmitted to the customer 1970.

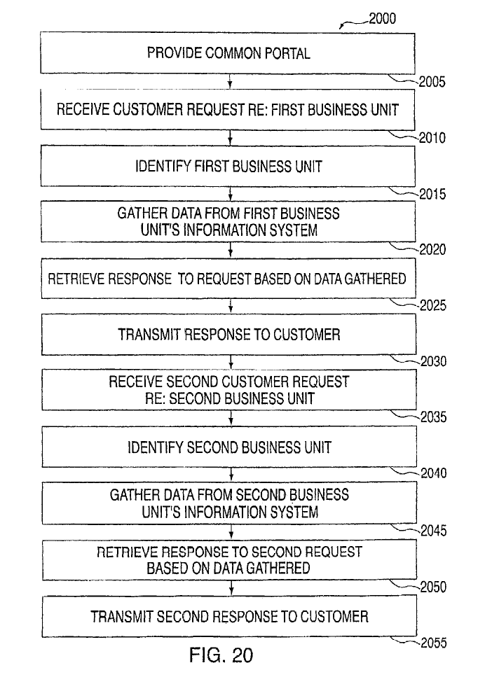

FIG. 20 illustrates an embodiment of a method according to the present invention for providing e-business services between a customer and a plurality of business units of a diversified company, each business unit associated with a corresponding information system. First, a common portal is provided, 2005. At 2010, a customer request regarding a first business unit is received. At 2015, the first business unit is identified. Data is gathered from the first business unit's information system 2020, and a response is retrieved to the request based on the data gathered 2025. At 2030, the response is transmitted to the customer. At 2035, a second request is received regarding a second business unit. The second business unit is identified 2040, and data is gathered form the second business unit's information system 2045. At 2050, the a response to the second request is retrieved based on the gathered data. The second response is transmitted to the customer 2055.

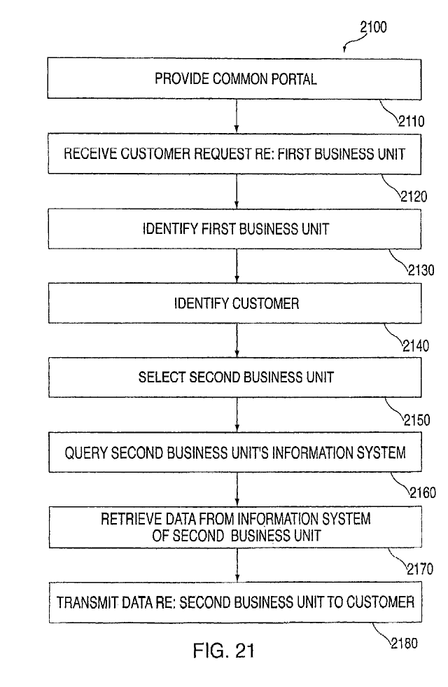

FIG. 21 shows an embodiment of a method according to the present invention for initiating and completing an-e-business transaction over a network between a customer and a plurality of business units of a diversified company, each business unit associated with a corresponding information system, the customer being identified by a set of customer-specific information. A common portal is provided 2110, and a customer request regarding a first business unit is received 2120. The first business unit is identified 2130, and at 2140, the customer is identified. At 2150, a second business unit is selected, and at 2160, the second business unit's information systems is queried. The data is then retrieved from the information system of the second business unit 2170, and data regarding the second business unit is transmitted to the customer 2180.

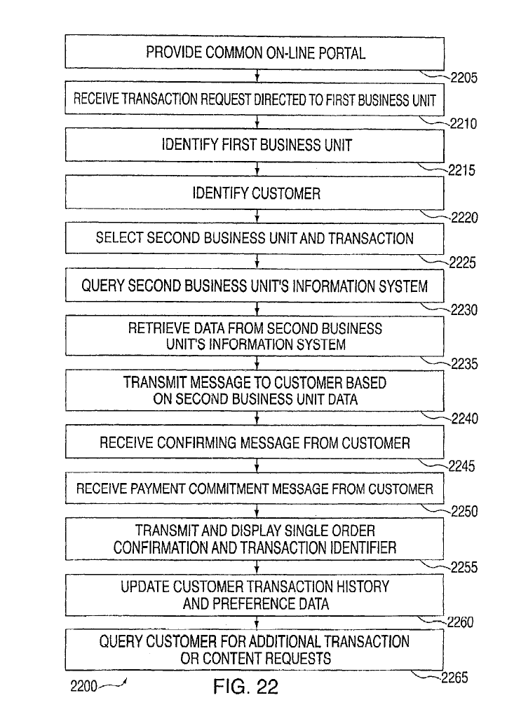

FIG. 22 illustrates an embodiment of a method according to the present invention, in an e-business information system, for initiating and completing an e-business transaction over a network between a customer and a plurality of business units of a diversified company, each business unit associated with a corresponding information system in communication with the electronic business information system, the customer being identified by a set of customer-specific information. At 2205 a common on-line portal is provided. A transaction request directed to a first business unit is received 2210. The first business unit is identified 2215, and the customer is identified 2220. At 2225, a second business unit and transaction are selected, and at 2230, the second business unit's information system is identified. Data is retrieved from the second business unit's information system 2235, and a message is transmitted to the customer based on the second business unit's data 2240. At 2245, a confirming message is received from the customer, and at 2250, a payment commitment message is received form the customer. A single order confirmation and transaction identifier is transmitted and displayed 2255, and the customer's transaction history and preference data are updated 2260. At 2265, the customer is queried for additional transaction or content requests.

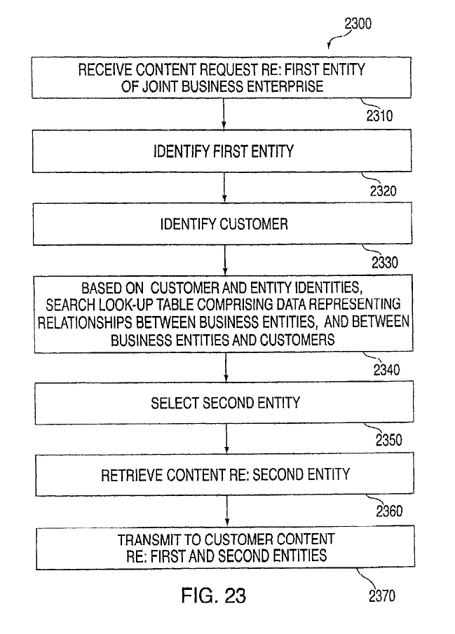

FIG. 23 shows an embodiment of a method according to the present invention for providing a customer with content relating to the offerings of a plurality of business entities associated with a joint business enterprise. At 2310, a content request regarding a first entity of the joint business enterprise is received. The first entity is then identified 2320, as well as the customer 2330. At 2340, based on the customer and entity identities, a look-up table comprising data representing relationships between business entities, and between business entities and customers, is searched. A second entity is selected 2350, content is received regarding that entity 2360, and the content regarding the first and second entities is transmitted to the customer 2370.

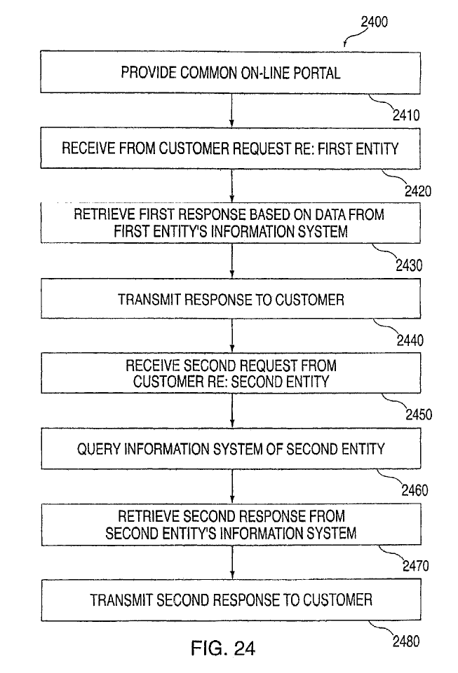

FIG. 24 illustrates an embodiment of a method according to the present invention for providing e-business services between a customer and a plurality of business entities of a joint business enterprise, each business entity associated with a corresponding information system. At 2410, an on-line portal is provided. A request regarding a first entity of the joint business enterprise is received 2420, and a first response based on data form the first entity's information system is retrieved 2430. At 2440, a response is transmitted to the customer. A second request regarding a second entity is then received from the customer 2450. The information system of the second entity is then queried 2460, and a second response is retrieved from the second entity's information system 2470. At 2480, a second response is transmitted to the customer.

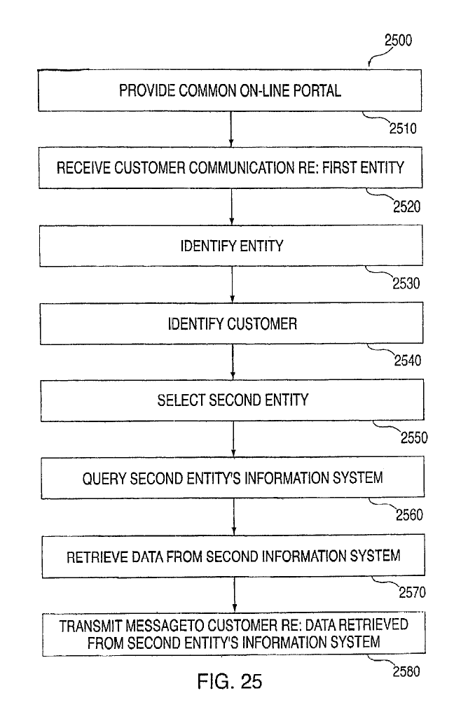

FIG. 25 shows an embodiment of a method according to the present invention for initiating and completing an e-business transaction over a network between a customer and a plurality of business entities of a joint business enterprise, the customer being identified by a set of customer-specific information. At 2510, a common portal is provided whereby a customer request regarding a first business entity is received 2520. At 2530, the first business entity is identified, and at 2540, the customer is identified. A second business entity is selected 2550, and the second business entity's information systems is queried 2560. At 2570, the data is retrieved from the information system of the second business entity, and at 2580, data regarding the second business entity is transmitted to the customer.

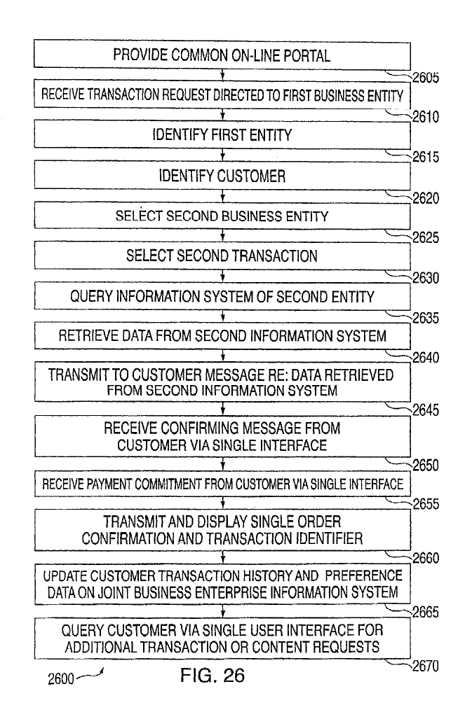

FIG. 26 illustrates a method according to the present invention for initiating and completing, in an electronic business information system, an e-business transaction over a network between a customer and a plurality of business entities of a joint business enterprise, the customer being identified by a set of customer-specific information. A common on-line portal is provided 2605, and a transaction request directed to a first business entity is received 2610. At 2615, the first business entity is identified, and at 2620, the customer is identified. A second business entity is selected 2625, and a second transaction is selected 2630. At 2635, the second business entity's information system is queried. Data is then retrieved from the second business entity's information system 2640, and a message is transmitted to the customer based on the data retrieved from the second business entity's information system 2645. At 2650, a confirming message is received from the customer, and at 2655, a payment commitment message is received form the customer. A single order confirmation and transaction identifier is transmitted and displayed 2660, and the customer's transaction history and preference data are updated on the information system of the joint business enterprise 2665. At 2670, the customer is then queried via the single user interface for additional transaction or content requests.

To invoke advantages of the various systems and methods according to the present invention, a customer uses a computer connected to a communications network in order to communicate with, and enter into transactions with, the diversified company. The customer signs on to the online system of the diversified company through a single user interface that allows access to information about the offerings of the various business units, as well as the means to place orders for any combination of such offerings. The diversified company, through its online system, presents the customer with tailored information regarding available goods and services (based on the customer's profile and purchase history), fields inquiries from the customer, accesses responsive data from the disparate systems of the appropriate business units, synthesizes the multiple responses for presentation to the customer, accepts an order from the customer for a bundle of goods and services, alerts each of the systems of the appropriate business units of the need for the requested items, communicates availability to the customer, processes payment, arranges for delivery to the customer, and transmits updating information to the credit, inventory and other systems of the individual business units.

An embodiment of a method according to this aspect of the present invention comprises several steps. The customer first directs its computer to the diversified company's single online interface, which resides in a “presentation layer” of the company's computer system. The presentation layer includes a web server, providing content over a network (e.g., the Internet) to a customer's computer; a personalization engine that tailors content and transaction detail for a given customer based on a customer's profile, transaction history, and usage patterns; and a content management application that stores, maintains and transmits to the customer interface instantly relevant content from the individual content repositories of the diversified company's operating units. The presentation layer functions as the main content interface with the customer, as well as the consolidator and formatter of transactions data and other content from across the diversified company's network for presentation to the customer.

The method also includes the step of the diversified company's recognizing the customer's sign-in and presenting the customer with tailored content such as news from the customer's industry, product information from business units with whom the customer has done transactions in the past, status of current orders or projects, lists of relevant resources and company contacts, and links to an inquiry input screen. The content management and personalization functions of the presentation layer drive the delivery of this tailored content to the customer. The web page additionally provides an intuitive, clickable navigation function that appears seamless to the customer as the customer navigates among content from the disparate business units.

The method also includes the step of accepting a customer request for content relating to one or more business units, including product specifications, pricing, order or project status, or troubleshooting; filtering the request through the personalization and content management engines of the presentation layer; retrieving the requested content from the respective business unit content repositories; and filtering and formatting the content through the content management and personalization engines for presentation to the customer. The customer has thus received content from the multiple business units relevant to it at that moment, without perceiving having interacted with any entity other than the single diversified company.

According to another aspect of the invention, a customer may engage in e-commerce transactions with the various units of the diversified company utilizing its single interface with the diversified company. The method according to this aspect of the invention includes the step of the customer's transmitting, via a single, uniform, pre-formatted input screen, an e-commerce order requesting products or services from one or more different business units of the diversified company. The form resides on the presentation layer of the diversified company's network, which transmits the order information to an “applications” layer. The applications layer includes a centralized, combined product database, an e-commerce server, and an EAI. The EAI facilitates sharing of data and business process rules among the databases and applications of the business units and of the diversified company. The EAI's functionality includes: database linking, in which databases share and duplicate information; application linking, in which the diversified company or its units share data or processes between two or more applications; and data warehousing, in which data is extracted from multiple sources and written to a single database for analysis. The e-commerce server receives the request from the presentation layer; queries the product data server for price, availability, and other data; and creates a customer order by drawing real-time content from the EAI and its underlying applications. The e-commerce server then transmits order and payment information back to the presentation layer for formatting and transmits updates to the legacy systems of the business units residing in a “legacy applications” layer.

According to another aspect of the invention, the applications layer transmits updating information based on customer orders to the individual business units via the legacy applications layer. The legacy applications layer includes the legacy systems of the business units, as well as a data server holding legacy data. This layer allows the individual business units to maintain accurate records of transactions being entered into on their behalf by the processing taking place in the applications and presentation layers. The diversified company thus serves both the individual business unit at the back end through the legacy applications layer, while serving the customer at the front end through the presentation layer. The applications layer provides the link that allows the company to transform the disparate offerings of the business units into the particular uniform offering demanded by the customer at any given time.

In addition to the embodiments of the aspects of the present invention described above, those of skill in the art will be able to arrive at a variety of other arrangements and steps which, if not explicitly described in this document, or in the particular described order, nevertheless embody the principles of the invention and fall within the scope of the appended claims.

What is claimed is:

1. A method for providing e-business services between a customer and a plurality of business units of a diversified company, each business unit associated with a corresponding information system, the method comprising the steps of:
a. providing a common on-line portal for the plurality of business units, the common portal comprising a single user interface for the plurality of business units;
b. receiving from the customer via the single user interface a first request directed to a first of the plurality of business units of the diversified company;
c. as a function of the first request, retrieving a first response based on data derived from the information system associated with the first business unit;
d. transmitting the response to the customer via the single user interface;
e. receiving from the customer, via the single user, interface a second request directed to a second of the plurality of business units of the diversified company;
f. as a function of the second request, retrieving a second response based on data derived from the information system associated with the second business unit, the information system associated with the second unit differing from the information system associated with the first business unit;
g. transmitting the second response to the customer via the single user interface;
whereby the customer may direct requests to at least two business units electronically via the common on-line portal.

2. A method for providing e-business services between a customer and a plurality of business entities of a joint business enterprise, each business unit associated with a corresponding information system, the method comprising the steps of:
a. providing a common on-line portal for the plurality of business entities, the common portal comprising a single user interface for the plurality of business entities;
b. receiving from the customer via the single user interface a first request directed to a first of the plurality of business entities of the joint business enterprise;
c. as a function of the first request, retrieving a first response based on data derived from the information system associated with the first business entity;
d. transmitting the response to the customer via the single user interface;
e. receiving from the customer via the single user interface a second request directed to a second of the plurality of business entities of the diversified company;
f. as a function of the second request, retrieving a second response based on data derived from the information system associated with the second business entity, the information system associated with the second entity differing from the information system associated with the first business entity;
g. transmitting the second response to the customer via the single user interface;
whereby the customer may direct requests to at least two business entities electronically via the common on-line portal.
